(19) United States
(12) Patent Application Publication
(10) Pub. No.: US 2004/0151810 A1
(43) Pub. Date: Aug. 5, 2004

(54) Sweet

(75) Inventor: Herbert Mederer, Furth (DE)

Correspondence Address: BROWDY AND NEIMARK, P.L.L.C., 624 NINTH STREET, NW, SUITE 300, WASHINGTON, DC, 20001-5303, US

(73) Assignee: Mederer GmbH, Furth (DE)

(21) Appl. No.: 10/762,311

(22) Filed: Jan. 23, 2004

(30) Foreign Application Priority Data
Jan. 23, 2003 (DE) 203 00 983.5

(51) Int. Cl. A23L 1/00

(52) U.S. Cl. 426/99

(57) ABSTRACT

A multilayer sweet comprises a core of a fruit-gum compound, and a fatty layer which envelops the core, and a sugary coating which envelops the fatty layer, and it offers a novel taste and flavor as compared to familiar sweets.

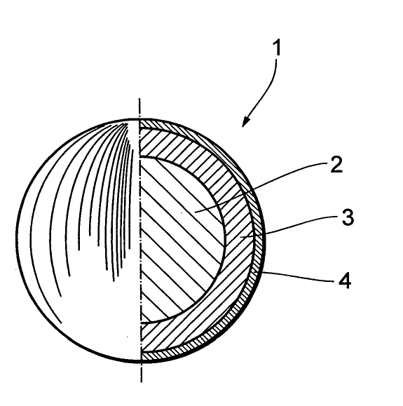

### BACKGROUND OF THE INVENTION

1. Field of the Invention

The invention relates to a multilayer sweet.

2. Background Art

Sweets of the generic type are known for instance as chocolate-coated jelly sweets.

There is a demand for sweets that will offer the experience of a different, novel kind of taste and flavor as compared to these familiar sweets.

### SUMMARY OF THE INVENTION

The object of meeting this demand is attained in a sweet that comprises a core of a fruit-gum compound; a fatty layer which envelops the core; and a sugary coating which envelops the fatty layer.

A sweet of this type provides for a novel taste combined from the fruity flavor of the fruit gum compound on the one hand and the creamy consistency, and flavor determined thereby, of the fatty layer on the other hand, this experienced flavor still being supported by the sugary coating.

A fatty layer which contains a flavor carrier, in particular yoghurt, may come in various flavors. These flavors may be adjusted in particular to the respective fruity taste of the fruit-gum compound.

A sugary coating which is a thin coating containing sugar, when combined with the softer and creamy fatty layer thereunder, provides for additional taste and flavor experienced when the sweet is crunched and the sugar-coating breaks.

A sugary coating can be colored pleasantly. In particular, a plurality of these sweets of various colors may be offered in an attractive pack.

Details of the invention will become apparent from the ensuing description of an exemplary embodiment, taken in conjunction with the drawing.

### BRIEF DESCRIPTION OF THE DRAWING

The only figure illustrates a sweet that is partly cut open.

### DESCRIPTION OF A PREFERRED EMBODIMENT

The sweet, which is designated in its entirety by 1, has a diameter of approximately 15 mm, comprising a core 2 of a fruit-gum compound. The core 2 has a diameter of approximately 10 mm. The core 2 is enveloped by a fatty layer 3 in the form of a fatty frosting i.e., a compound similar to chocolate with cocoa butter replaced by another vegetable fat. The fatty layer 3 has a thickness of 2 mm, containing a flavor carrier in the form of yoghurt which is stirred as a powder into the fatty layer 3. Instead of the fatty frosting, chocolate, for example white chocolate, may be used as a fatty layer 3.

The fatty layer 3 is enveloped by a sugary coating 4, which is a thin coating containing sugar. The sugary coating 4 is colored. Commercial food dyes may be used. The sugary coating 4 has a thickness of distinctly less than 1 mm.

What is claimed is:

1. A sweet (1), comprising
a core (2) of a fruit-gum compound;
a fatty layer (3) which envelops the core (2); and
a sugary coating (4) which envelops the fatty layer (3).

2. A sweet according to claim 1, wherein the fatty layer (3) contains a flavor carrier, in particular yoghurt.

3. A sweet according to claim 2, wherein the fatty layer (3) is creamy.

4. A sweet according to claim 1, wherein the sugary coating (4) is a thin coating containing sugar.

5. A sweet according to claim 1, comprising a colored sugary coating (4).
